(19) United States
(12) Patent Application Publication
(10) Pub. No.: US 2022/0176170 A1
(43) Pub. Date: Jun. 9, 2022

(54) FACE MASK HAVING PLURALITY OF CLOSEABLE FLAPS

(71) Applicant: De'Angelo Daniels, Miramar, FL (US)

(72) Inventor: De'Angelo Daniels, Miramar, FL (US)

(21) Appl. No.: 17/508,906

(22) Filed: Oct. 22, 2021

Related U.S. Application Data
(60) Provisional application No. 63/094,940, filed on Oct. 22, 2020.

(51) Int. Cl. A62B 18/08; A41D 13/11

(52) U.S. Cl. CPC A62B 18/086; A62B 18/084; A41D 13/1107

(57) ABSTRACT

A face mask having plurality of closeable flaps which includes a mask body having a pair of ear loops extending therefrom as well as a first flap member and a second flap member integrated therewith. The first flap member extends across a central portion of the mask body and can be moved between a closed position and an open position. The second flap member is positioned within the first flap member and can be moved between a closed position and an open position. Through the action of the first flap member and the second flap member, a large opening or a small opening can be selectively formed in the mask body while the face mask having plurality of closeable flaps remains in place on a wearer.

### CROSS REFERENCE TO RELATED APPLICATIONS

This application claims the benefit of and incorporates by reference co-pending U.S. provisional patent application serial number 63/094,940 filed Oct. 22, 2020.

### BACKGROUND OF THE INVENTION

### Field of the Invention

This invention relates generally to wearable protective devices and, more particularly, to a wearable face mask which selectively covers a wearer's mouth and nose.

### Description of the Prior Art

The use and design of mouth and nose covering face masks, such as surgical masks, cloth masks, and single use filtering facepiece respirators (such as N95 masks), is well established. When worn by a user, these types of masks typically cover the mouth and nose of the wearer so as to, at minimum, catch bacteria and other microbes shed in liquid droplets and aerosols coming from the wearer's mouth and nose. Many of these types of masks also operate to protect the wearer from breathing in air pollution particles. And other, more advanced types of such face masks, may also operate to filter air being breathed in and thereby offer protection to the wearer from breathing in airborne bacteria or viruses.

A limitation which still exists, however, is that because these types of face masks are specifically for covering a wearer's mouth, the wearer typically is unable to eat or drink without removing their mask. As such, a wearer desiring to eat or drink must either continually remove and replace their mask or simply remove the mask for the entirety of the time that they will be (or could be) eating or drinking. Having to remove and subsequently one's mask, however, not only undermines the entire point of wearing the mask in the first place, it also subjects the surfaces of the mask to contamination which could in fact bring harmful microbes into closer proximity to a wearer's nose and mouth. In this regard, wearing a mask could actually increase a wearer's risk of exposing themselves to a pathogen.

Thus, there remains a need for a mouth and nose covering face mask which includes a plurality of movable barriers which allow temporary openings to be formed in the mask to allow a wearer to eat or drink without removing the face mask. It would additionally be desirable for such a face mask to employ closeable flaps as movable barriers which can be moved by a wearer without the wearer having to touch any surface of the flap that is ever placed in contact with the wearer's face. It would be furthermore desirable for such a face mask having plurality of closeable flaps to include for each flap a plurality of sealing mechanisms.

### SUMMARY OF THE INVENTION

The present disclosure describes a face mask having plurality of closeable flaps that includes: a mask body having a pair of lateral ends on opposite sides of the mask body and a pair of holding members, such as ear loops, with each respective holding member attached to one of the lateral ends; a first flap member formed from a portion of the mask body and configured to be releasably fixed in a first closed position as well as to move between the first closed position and a first open position defined by the creation of a first opening in the mask body; and a second flap member formed from a portion of the first flap member and configured to be releasably fixed in a second closed position as well as to move between the second closed position and a second open position defined by the creation of a second opening in the mask body.

It is an object of this invention to provide a face mask having plurality of closeable flaps which form a plurality of movable barriers which allow temporary openings to be formed in the mask to allow a wearer to eat or drink without removing the face mask.

It is another object of this invention to provide a face mask having plurality of closeable flaps which can be moved by a wearer without the wearer having to touch any surface of the flap that is ever placed in contact with the wearer's face.

It is yet another object of this invention to provide a face mask having plurality of closeable flaps which includes for each flap a plurality of sealing mechanisms.

These and other objects will be apparent to one of skill in the art.

### BRIEF DESCRIPTION OF THE DRAWINGS

FIG. 1 is a side elevational view of a face mask having plurality of closeable flaps built in accordance with a first embodiment of the present invention, shown on a wearer in a closed configuration.

FIG. 2 is a front elevational view of a face mask having plurality of closeable flaps built in accordance with a first embodiment of the present invention, shown on a wearer in a small opening configuration.

FIG. 3 is a side elevational view of a face mask having plurality of closeable flaps built in accordance with a first embodiment of the present invention, shown on a wearer in a large opening configuration.

FIG. 4 is a front elevational view of a face mask having plurality of closeable flaps built in accordance with a first embodiment of the present invention, shown on a wearer in a large opening configuration.

FIG. 5 is a side elevational view of a face mask having plurality of closeable flaps built in accordance with a second embodiment of the present invention, shown on a wearer in a closed configuration.

FIG. 6 is a front elevational view of a face mask having plurality of closeable flaps built in accordance with a second embodiment of the present invention, shown on a wearer in a small opening configuration.

FIG. 7 is a side elevational view of a face mask having plurality of closeable flaps built in accordance with a second embodiment of the present invention, shown on a wearer in a large opening configuration.

FIG. 8 is a front elevational view of a face mask having plurality of closeable flaps built in accordance with a second embodiment of the present invention, shown on a wearer in a large opening configuration.

### DETAILED DESCRIPTION OF THE INVENTION

Described herein is a face mask having plurality of closeable flaps which includes a mask body having a pair of ear loops extending therefrom as well as a first flap member and a second flap member integrated therewith. The first flap member extends across a central portion of the mask body and can be moved between a closed position and an open position. The second flap member is positioned within the first flap member and can be moved between a closed position and an open position. Through the action of the first flap member and the second flap member, a large opening or a small opening can be selectively formed in the mask body while the face mask having plurality of closeable flaps remains in place on a wearer.

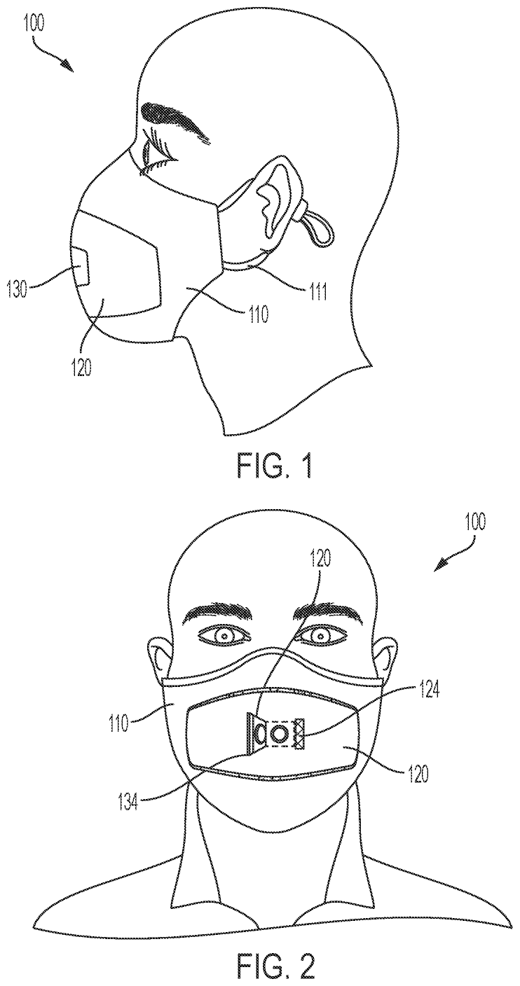

Referring now to the drawings and, in particular, FIGS. 1, 2, 3, and 4, a face mask 100 built in accordance with a first embodiment of the present disclosure is shown as a mask body 110 that has a pair of ear loops 111, a first flap member, 120, and a second flap member 130. The mask body 110 includes two opposing lateral ends, with one of the ear loops 111 attached to each of the lateral ends. The mask body 110 is sized and shaped such that when placed against the face of a wearer, with the ear loops 111 looping around the ears of the wearer, the mask body 110 will fit over and cover the nose and mouth of the wearer.

The mask body 110 may be formed of substantially any material that is used to make mouth and nose covering face masks. As such, embodiments of the mask body 110 may be formed from a common textile material, such as cotton. Embodiments of the mask body 110 may be alternatively be formed from a nonwoven fabric, a paper material, or a thermoplastic material.

The ear loops 111 may be formed from an elastic fabric material.

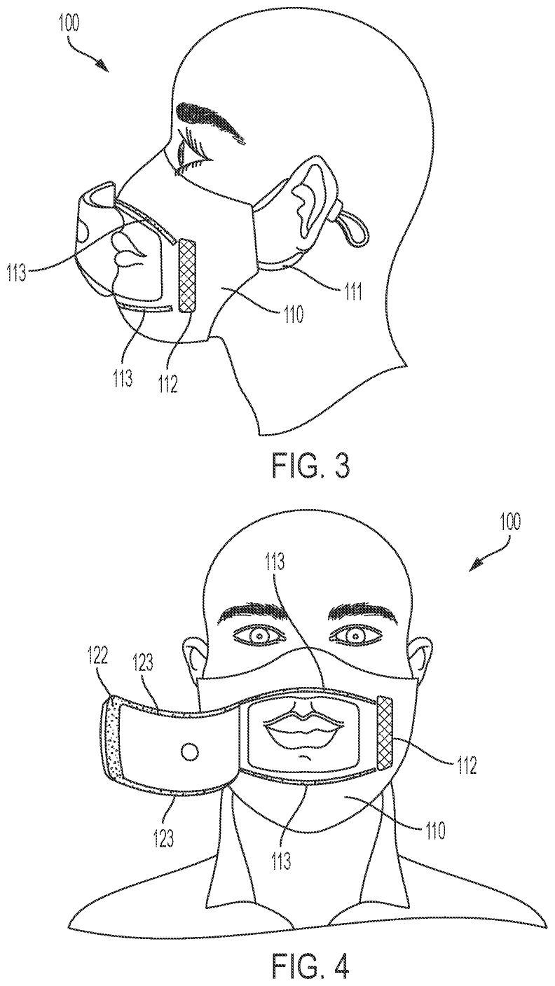

The first flap member 120 is formed from a portion of the mask body 110, and oriented to extend across a central portion of the mask body 110 such that when the face mask 100 is in place on a wearer's face, the first flap member 120 is positioned over the wearer's mouth. In the first embodiment of the face mask 100, the first flap member 120 has a substantially rectangular shape with four sides, and is fixedly attached to the mask body 110 on one side and releaseably attached on the other three sides. In this regard, when the releaseably attached sides of the first flap member 120 are disengaged from the mask body 110, the first flap member 120 can swing between a closed position, as illustrated in FIGS. 1 and 2, and an open position, as illustrated in FIGS. 3 and 4. It is appreciated that when in the open position, a wearer of the face mask 100 can access their entire mouth to eat or for any reason without having to remove the face mask 100.

On the side of the first flap member 120 opposite where it is fixedly attached to the mask body 110, the first flap member 120 and mask body 110 may be releaseably attached through a pair of opposing attachments strips 112, 122 formed from fabric hook and loop fastener material. On the two other sides, the first flap member 120 and mask body 110 may be releaseably attached through upper and lower zipper mechanisms 113, 123 that are integral with the corresponding edges of both the first flap member 120 and mask body 110. It is appreciated that the zipper mechanisms 113, 123 may allow for a more secure releaseable attachment and the attachments strips 112, 122 may allow for the first flap member 120 to be opened and closed more quickly (while the zipper mechanisms 113, 123 are already disengaged).

The second flap member 130 is formed from a portion of the first flap member 120, and positioned in a central portion of the first flap member 120 such that when the face mask 100 is in place on a wearer's face, the second flap member 130 is positioned right at the middle of the wearer's mouth. In the first embodiment of the face mask 100, the second flap member 130 has a substantially rectangular shape with four sides, and is fixedly attached to the first flap member 120 on one side and releaseably attached to the side opposite the side where it is fixedly attached. The releaseable attachment of the second flap member 130 and the first flap member 120 may be through a pair of opposing small connecting strips 124, 134 formed from fabric hook and loop fastener material. In this regard, when the releaseably attached side of the second flap member 130 is disengaged from the first flap member 120, the second flap member 130 can swing between a closed position, as illustrated in FIG. 1, and an open position, as illustrated in FIG. 2. It is appreciated that when in the open position, a wearer of the face mask 100 can fit a straw through the second flap member 130 and into their mouth to drink without having to remove the face mask 100 or even open the first flap member 120.

It is contemplated that when the first flap member 120 and the second flap member 130 are both in their respective closed positions, the face mask 100 is in the closed configuration, when the first flap member 120 is in the open position and the second flap member 130 is in the closed position, the face mask 100 is in the large opening configuration, and when the first flap member 120 is in the closed position and the second flap member 130 is in the open position, the face mask 100 is in the small opening configuration.

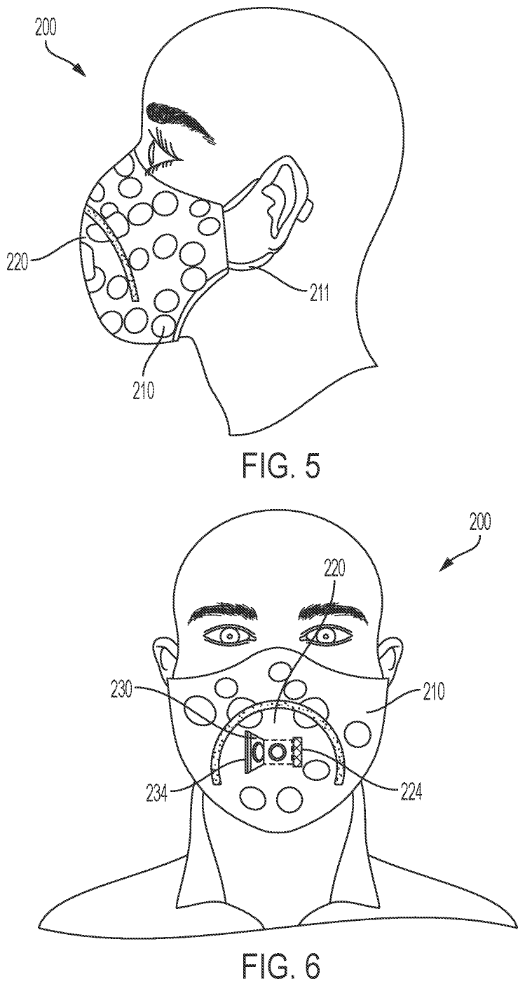

Referring now to the drawings and, in particular, FIGS. 5, 6, 7, and 8, a face mask 200 built in accordance with a second embodiment of the present disclosure is also formed from a mask body 210 that has a pair of ear loops 211, a first flap member, 220, and a second flap member 230. As with the first embodiment, the mask body 210 includes two opposing lateral ends, with one of the ear loops 211 attached to each of the lateral ends. And as with the first embodiment, the mask body 210 is sized and shaped such that when placed against the face of a wearer, with the ear loops 211 looping around the ears of the wearer, the mask body 210 will fit over and cover the nose and mouth of the wearer.

In addition, the mask body 210 and ear loops 211 of the second embodiment may be formed of substantially the same materials as in the first embodiment.

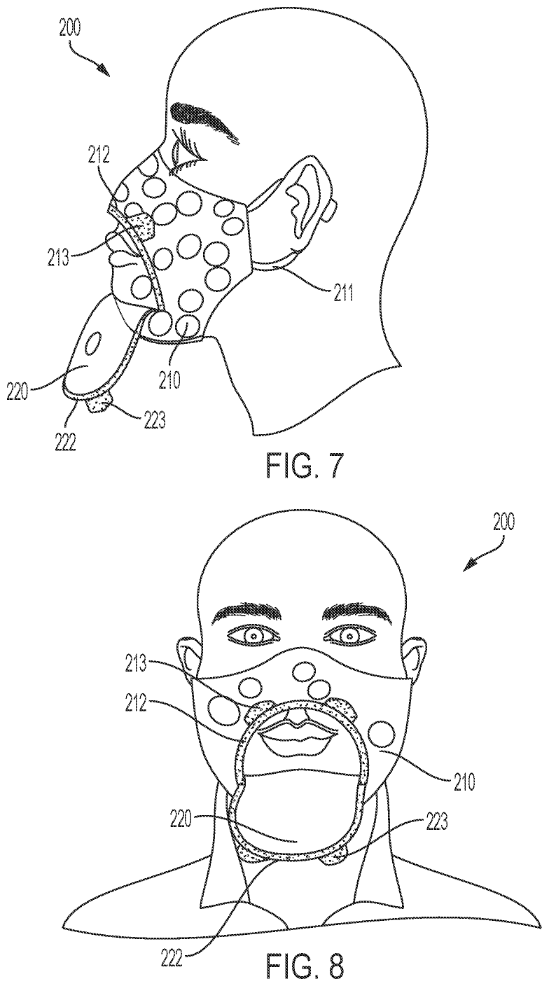

The first flap member 220 is formed from a portion of the mask body 210, and oriented in a central location on the mask body 210 such that when the face mask 200 is in place on a wearer's face, the first flap member 220 is positioned over the wearer's mouth. In the second embodiment of the face mask 200, the first flap member 220 has a semi circular shape with is linear bottom side being fixedly attached to the mask body 210 and its remaining curved edge being releaseably attached to the first flap member 220. In this regard, when the releaseably attached edge of the first flap member 220 is disengaged from the mask body 210, the first flap member 220 can swing between a closed position, as illustrated in FIGS. 5 and 6, and an open position, as illustrated in FIGS. 7 and 8. It is appreciated that when in the open position, a wearer of the face mask 200 can access their entire mouth to eat or for any reason without having to remove the face mask 200.

The releaseably attached edge of the first flap member 220 may be releaseably attached to the mask body 210 through both a zipper mechanism 212, 222 that is integral with a corresponding edge of both the first flap member 220 and mask body 210 and a a pair of opposing attachments strips 213, 223 formed from fabric hook and loop fastener material. It is appreciated that the zipper mechanism 212, 222 may allow for a more secure releaseable attachment and the attachments strips 213, 223 may allow for the first flap member 220 to be opened and closed more quickly (while the zipper mechanism 212, 222 is already disengaged).

The second flap member 230 is structured and operates much in the same way as the second flap member from the first embodiment. In this regard, the second flap member 230 is formed from a portion of the first flap member 220, and positioned in a central portion of the first flap member 220 such that when the face mask 200 is in place on a wearer's face, the second flap member 230 is positioned right at the middle of the wearer's mouth. The second flap member 230 has a substantially rectangular shape with four sides, and is fixedly attached to the first flap member 220 on one side and releaseably attached to the side opposite the side where it is fixedly attached. The releaseable attachment of the second flap member 230 and the first flap member 220 may be through a pair of opposing small connecting strips 224, 234 formed from fabric hook and loop fastener material. In this regard, when the releaseably attached side of the second flap member 230 is disengaged from the first flap member 220, the second flap member 230 can swing between a closed position, as illustrated in FIG. 5, and an open position, as illustrated in FIG. 6.

It is contemplated that when the first flap member 220 and the second flap member 230 are both in their respective closed positions, the face mask 200 is in the closed configuration, when the first flap member 220 is in the open position and the second flap member 230 is in the closed position, the face mask 200 is in the large opening configuration, and when the first flap member 220 is in the closed position and the second flap member 230 is in the open position, the face mask 200 is in the small opening configuration.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A face mask having plurality of closeable flaps, comprising:
a mask body having a pair of lateral ends on opposite sides of the mask body and a pair of holding members, with each respective holding member attached to one of the lateral ends;
a first flap member formed from a portion of the mask body and configured to be releasably fixed in a first closed position as well as to move between the first closed position and a first open position defined by the creation of a first opening in the mask body; and
a second flap member formed from a portion of the first flap member and configured to be releasably fixed in a second closed position as well as to move between the second closed position and a second open position defined by the creation of a second opening in the mask body.
